(19) United States
(12) Patent Application Publication
(10) Pub. No.: US 2006/0284824 A1
(43) Pub. Date: Dec. 21, 2006

(54) Luminance auto-adjustment for displays

(76) Inventor: Yu-Kuang Yeh, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/155,491

(22) Filed: Jun. 20, 2005

(51) Int. Cl. G09G 3/36

(52) U.S. Cl. 345/102

(57) ABSTRACT

The present invention provides a luminance auto-adjustment device for the display, which comprises a light source-detecting module and a voltage modulation module, which are set in the power control circuit of the rear-projection fluorescent tube of the display. The light source-detecting module is used to sense the external luminance, based on which the voltage modulation module is used to modulate the voltage value of the rear-projection fluorescent tube. The rear-projection fluorescent tube of the display can automatically modulate the luminance according to the external luminance.

### FIELD OF THE INVENTION

The present invention relates to a luminance auto-adjustment device for displays, and more particularly to a luminance auto-adjustment device which is directly connected to the power control circuit of the rear-projection fluorescent tube of the display, and comprises a light source-detecting module and a voltage modulation module, whereas it can detect the external luminance so as to automatically adjust the luminance of the rear-projection fluorescent tube of the display.

### BACKGROUND OF THE INVENTION

As LCD (liquid crystal display) display is popularized, its application becomes more extensive. Since the brightness of LCD is controlled by the projection of the fluorescent tube in the backlight module, often the light source contrast between the screen and the external environment exists due to the variable external luminance. When the surrounding light is too bright, its contrast ratio of the picture that the screen shows is comparatively insufficient, making the user's eyes comparatively straining while watching the screen. When surrounding light too dark, the picture that the screen shows is relatively bright, which will cause the discomfort of user's eyes.

At present, there are displays capable of adjusting the brightness, but the function only takes effect manually. Utilization of the microprocessor together with the complicated control circuit to adjust the luminance of the screen, not only causes inconvenience, but also high costs.

Another conventional technology is that upon the operation by the user, the CPU conveys a signal to the light detecting module, which detects the external light and sends the result to CPU, which then outputs to the backlight control module. The backlight output module could be adjusted automatically according to the external light source condition. However, the said structure can carry out the brightness adjustment only after being touched off in advance by the user, and it cannot detect at all times as it is only semi-automatic adjustment. Since the CPU and the backlight control module are used to achieve the automatic adjustment, the parts are of high costs.

### SUMMARY OF THE INVENTION

The main objective of the present invention is to provide a luminance auto-adjustment device of simplified structure and lower costs, and its operating principle. The luminance auto-adjustment device comprises a light source-detecting module and a voltage modulation module, which are set in the power control circuit of the rear-projection fluorescent tube of the display. The light source-detecting module is used to sense the external luminance, based on which the voltage modulation module is used to modulate the voltage value of the rear-projection fluorescent tube. Whereas, the rear-projection fluorescent tube of the display can automatically modulate the luminance according to the external luminance.

### BRIEF DESCRIPTION OF THE DRAWINGS

FIG. 1 shows the simple block diagram of the present invention;

FIG. 2 shows the block diagram of the control of the present invention;

FIG. 3 shows the block diagram of another control of the present invention, and

FIG. 4 is the circuit diagram of the luminance auto-adjustment device.

### DETAILED DESCRIPTION OF THE PREFERRED EMBODIMENT

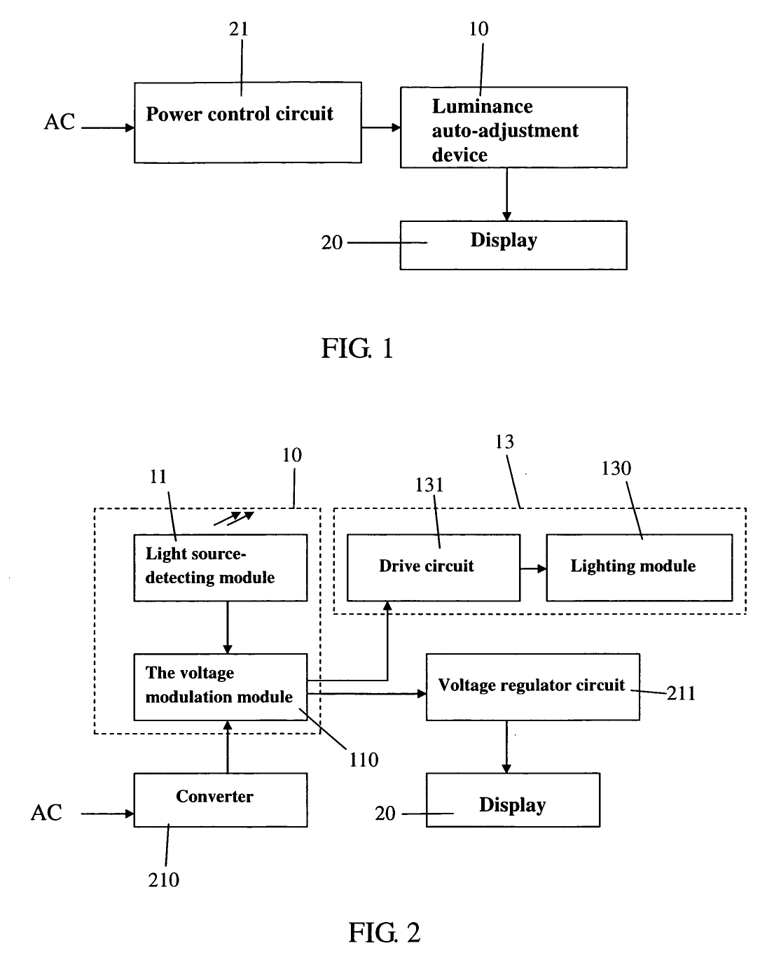

As shown in FIGS. 1-3, a luminance auto-adjustment device 10, sets on the power control circuit 21 of the rear-projection fluorescent tube to provide power for the display 20 so as to control the voltage value of the rear-projection fluorescent tube, and comprises:

at least one light source-detecting module 11; and

a voltage modulation module 110 that connects with the light source-detecting module 11 and controls the output voltage value according to the light source signal sensed by the light source-detecting module 11.

In the preferred embodiment shown in FIGS. 1-3, the power control circuit 21 comprises a converter 210 that changes the alternating current into direct current and a voltage regulator circuit 211.

In the preferred embodiment shown in FIGS. 1-3, the luminance auto-adjustment device is connected in series between the converter 210 and the voltage regulator circuit 211.

In the embodiment shown in FIG. 1, the luminance auto-adjustment device 10 is connected in series between the power control circuit 21 and the rear-projection fluorescent tube of the display 20.

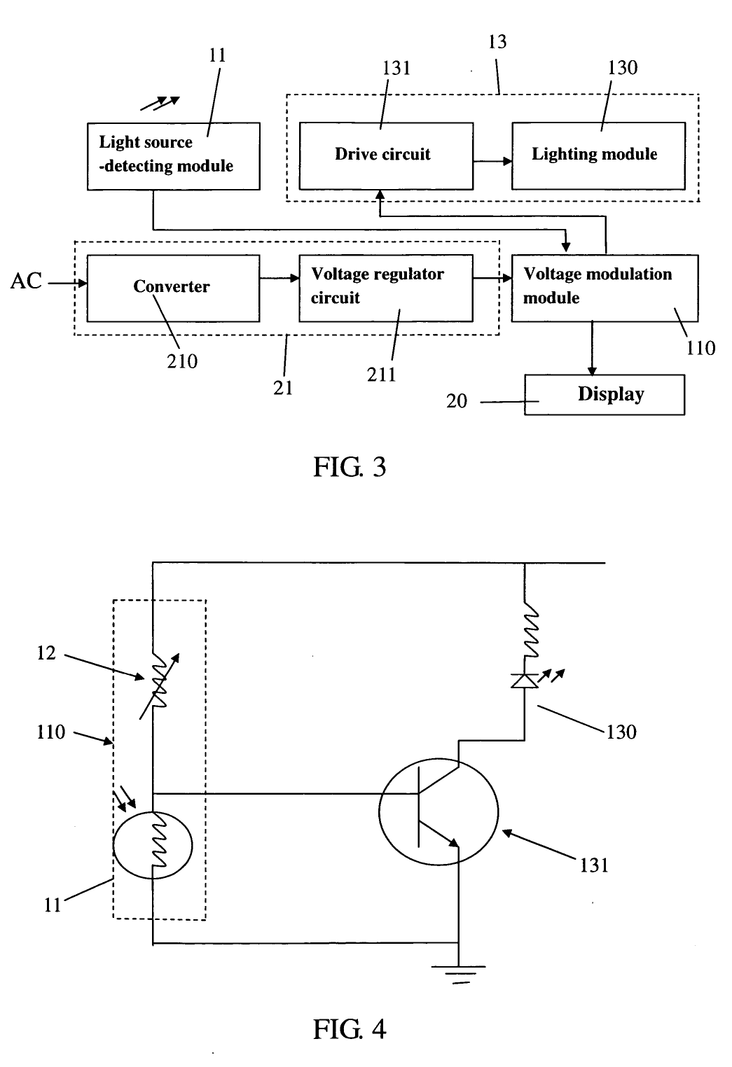

In the embodiment shown in FIGS. 2-3, the luminance auto-adjustment device 10 further comprises a lighting circuit 13, which is connected in parallel with the voltage modulation module 110.

In the embodiment shown in FIG. 4, the voltage modulation module 110 comprises a variable resistor 12 and a light source-detecting module 11 which are connected in series. In the preferred embodiment, the light source-detecting module 11 can be the photosensitive resistor.

In the embodiment shown in FIG. 4, the lighting circuit 13 comprises at least one lighting module 130 and a drive circuit 131 that starts the lighting module 130 (the drive circuit 131 can be a transistor).

In the preferred embodiment, the display 20 is the liquid crystal display (LCD) that contains a display panel and a rear-projection fluorescent tube.

In the preferred embodiment shown in FIGS. 2-4, when the surrounding light is brighter, the light source-detecting module 11 decreases the resistance value according to the change in the surrounding light, so as to relatively decrease the total resistance of the variable resistance 12 and the light source-detecting module 11, which causes the increase of the output voltage of the voltage modulation module 110. As a result, the luminance of the rear-projection fluorescent tube of the display 20 increases. Therefore, the discomfort of the user's eyes caused by the sharp contrast between the surrounding luminance and the screen luminance will be avoided.

When the surrounding luminance is lower, the light source-detecting module 11 increases the resistance value according to the surrounding light's change, so as to relatively increase the total resistance of the variable resistance 12 and the light source-detecting module 11, causing the decrease of the output voltage of the voltage modulation module 110. Therefore, the luminance of the rear-projection fluorescent tube of the display 20 decreases. When the voltage drop of the light source-detecting module 11 is larger, the transistor 131 can be conducted as well as the lighting module 130, so as to provide lighting for the keyboard.

Although the invention has been explained in relation to its preferred embodiment, it is to be understood that many other possible modifications and variations can be made without departing from the spirit and scope of the invention as hereinafter claimed.

What is claimed is:

1. A luminance auto-adjustment device for the display, which is can be connected to the power control circuit of the rear-projection fluorescent tube that supplies power to the display so as to control the voltage for the rear-projection fluorescent tube, and to adjust the luminance cast by the fluorescent tube, comprises:
at least one light source-detecting module, which is used to sense outside luminance; and
a voltage modulation module, which is connected to the light source-detecting module and control the voltage for the rear-projection fluorescent tube according to signal sensed by the light source-detecting module.

2. The device as claimed in claim 1, wherein said power control circuit comprises a converter, which can modulate the alternating current into the direct current, and a voltage regulator circuit.

3. The device as claimed in claim 1, wherein said power control circuit comprises a converter, which can modulate the alternating current into the direct current, and a voltage regulator circuit; the structure should be connected in series between the converter and the voltage regulator circuit.

4. The device as claimed in claim 1, wherein said luminance auto-adjustment device is connected in series between the power control circuit and the rear-projection fluorescent tube of the display.

5. The device as claimed in claim 1, wherein said luminance auto-adjustment device comprises a lighting drive circuit and a lighting module, and is connected in parallel to the voltage modulation module.

6. The device as claimed in claim 1, wherein said voltage modulation module comprises a variable resistor, which is connected in series to the light source-detecting module.

7. The device as claimed in claim 6, wherein said light source-detecting module is a photosensitive resistor, and the photosensitive resistor is connected in series to the variable resistor.

8. The device as claimed in claim 1, wherein said light source-detecting module is a photosensitive resistor.

9. The device as claimed in claim 1, wherein said display is the LCD (liquid crystal display), which contains the display panel and the rear-projection fluorescent tube.

10. A method for a display to auto-adjust its luminance comprises:
Step 1: sensing the outside luminance by a light source-detecting module;
Step 2: modulating the voltage value output according to the light source signal sensed by the light source detecting device; and
Step 3: producing the luminance rear-projection fluorescent tube of the display according to the modulated voltage value output.

11. The method as claimed in claim 10, wherein the method for modulating the voltage value output is by a voltage modulation module, the voltage modulation module and light source-detecting module are connected to the power-supple control circuit in the rear-projection fluorescent tube of the display.

12. The method as claimed in claim 11, wherein said light source-detecting module and the voltage modulation module are composed by a photosensitive resistor.

13. The method defined in claim 10, wherein if the external luminance sensed by the light source-detecting module is comparatively high, then the resistance of the light source-detecting module will be lower, the voltage will be lower, and the output voltage value of the voltage modulation module will be higher; thus, the luminance of the rear-projection fluorescent tube of the display will be higher.

14. The structure defined in claim 10, wherein if the external luminance sensed by the light source-detecting module is comparatively low, then the resistance of the light source-detecting module will be higher, the voltage will be higher, and the output voltage value of the voltage modulation module will be lower; thus, the luminance of the rear-projection fluorescent tube of the display will be lower.

15. The method defined in claim 10, wherein said display is the LCD (liquid crystal display), which contains the display panel and the rear-projection fluorescent tube.
